(19) United States
(12) Patent Application Publication
(10) Pub. No.: US 2026/0290031 A1
(43) Pub. Date: Sep. 24, 2026

(54) METHOD, SERVER, AND SYSTEM FOR PROVIDING ROAD CONDITION INFORMATION

(71) Applicants: HYUNDAI MOTOR COMPANY, Seoul (KR); KIA CORPORATION, Seoul (KR)

(72) Inventors: Kyoung Ryong Lee, Hwaseong-si (KR); Dae Bong An, Hwaseong-si (KR); Jong Han Kim, Hwaseong-si (KR); Seok Min Kim, Hwaseong-si (KR); Hye Won You, Hwaseong-si (KR); Kyung Woo Hur, Hwaseong-si (KR)

(73) Assignees: HYUNDAI MOTOR COMPANY, Seoul (KR); KIA CORPORATION, Seoul (KR)

(21) Appl. No.: 19/367,540

(22) Filed: Oct. 23, 2025

(30) Foreign Application Priority Data
Mar. 20, 2025 (KR) 10-2025-0036154

(51) Int. Cl. G06V 20/58; G06V 10/82; G06V 20/56

(52) U.S. Cl. CPC G06V 20/58; G06V 10/82; G06V 20/588

(57) ABSTRACT

In a method for providing road condition information, a server receives a road image provided by a first vehicle and situation information corresponding to the road image. The server determines, based on road type information included in the situation information, a neural network model, from among a plurality of neural network models, and detects a service target object from the road image based on the neural network model. The server stores road condition information associated with the detected service target object in a storage, and provides the road condition information to a second vehicle that enters a service target road.

### CROSS-REFERENCE TO RELATED APPLICATION

The present application claims the benefit of and priority to Korean Patent Application No. 10-2025-0036154, filed on Mar. 20, 2025, the entire contents of which are hereby incorporated herein by reference.

### TECHNICAL FIELD

The present disclosure relates to a road condition information provision technique.

### BACKGROUND

A service (road condition information provision service) is provided to inform a vehicle of information about a damage section, a slippery section, and a secondary crash risk section on a road.

Diagnosis of such road damage may be performed using vehicle sensor information. For example, the diagnosis may be performed based on whether Z-axis data of a 3-axis sensor of an AVNT (Audio Video Navigation Telematics) system exceeds a certain range, whether wheel sensor data of an ECS (Electronic Control Suspension) exceeds a certain range, a result of porthole determination by a CDCU (Chassis Domain Control Unit), and a result of porthole determination in analysis of road images.

However, there is a limit to the road damage diagnosis using such vehicle sensor information, especially the presence or absence of potholes in the road.

For example, in a case where there are actually multiple potholes even though the potholes have not been detected by the vehicle sensor, it is difficult to establish a criterion for determining whether or not there is road damage based on the vehicle sensor information, thereby resulting in pothole misdetection.

In addition, it is difficult to determine whether a certain road damage diagnosis or pothole detection is considered as an actual road damage or pothole.

The above information described in the background section is merely intended to enhance understanding of the background of the present disclosure and therefore may contain information that does not form the prior art already known to those having ordinary skill in the art to which the present disclosure pertains.

### SUMMARY

Aspects of the present disclosure provide a method, a server, and a system for providing road condition information, capable of providing accurate road condition information, such as accurate road pothole information.

Further aspects of the present disclosure provide a method, a server, and a system for providing road condition information, capable of providing accurate information on road potholes by learning road images including a plurality types of road conditions.

Further aspects of the present disclosure provide a method, a server, and a system for providing road condition information provision, capable of improving accuracy and efficiency of road pothole determination by performing learning excluding objects (for example, flat-potholes, cracks, filled-potholes, etc.) that are main misdetection targets in determining road potholes.

Further aspects of the present disclosure provide a method, a server, and a system for providing road condition information, capable of providing accurate road pothole information for each road type by determining road potholes using a neural network model trained based on different road images according to road types.

Further aspects of the present disclosure provide a method, a server, and a system for providing road condition information, capable of preventing unnecessary information notification in advance by releasing, in a case where a road pothole is not detected for a predetermined threshold time from a road image provided by a vehicle passing through a place where it is determined that the road pothole exists, the notification for the place.

Further aspects of the present disclosure provide a method, a server, and a system for providing road condition information, capable of performing maintenance for dangerous factors by detecting quasi-potholes using a separate neural network model trained based on road images including the quasi-potholes (for example, flat-potholes, cracks, etc.) and providing information on abnormal road conditions (for example, flat-potholes, cracks, etc.) to a relevant government office.

The aspects of the present disclosure are not limited to the above-mentioned aspects. Other aspects not mentioned herein should be more clearly understood by those having ordinary skill in the art from the following description.

In accordance with an aspect of the present disclosure, a method for providing road condition information is provided. The method includes receiving, by a server, a road image provided by a first vehicle and situation information corresponding to the road image. The method also includes determining, by the server, based on road type information included in the situation information, a neural network model, from among a plurality of neural network models, to be used to detect a service target object from the road image. The method additionally includes detecting the service target object from the road image based on the neural network model. The method further includes storing road condition information associated with the detected service target object in a storage. The method additionally includes providing the road condition information to a second vehicle that enters a service target road.

The plurality of neural network models may be trained to detect service target objects from images acquired from respective road types among a plurality of road types.

The plurality of road types may have different speed limits.

The service target objects detectable by the plurality of neural network models may have at least one of different size ranges or different volume ranges.

The service target object may include at least one of a pothole or an obstacle other than a pothole.

Providing the road condition information may include providing the road condition information based on road types and service provision information preset according to the service target object.

The preset service provision information may include an information provision duration. The information provision duration may be set to be longer as a speed limit according to the road type becomes higher. The information provision duration for the service target object that is a pothole may be set to be longer than the information provision duration for the service target object that is an obstacle other than a pothole.

Providing the road condition information may include: receiving at least one of driving data or sensor data from a third vehicle passing through a place where the service target object is located, while providing the road condition information; resetting the preset service provision information based on at least one of the driving data or the sensor data received from the third vehicle; and providing the road condition information based on the reset service provision information.

Resetting the service provision information may include resetting the service provision information based on determining, based on the sensor data received from the third vehicle, the vehicle body control for the third vehicle has occurred.

Resetting the service provision information may include resetting the service provision information based on determining, based on the driving data received from the third vehicle, that there is an abnormality in a driving state of the third vehicle.

The preset service provision information may include an information provision duration. Resetting the service provision information may include applying a weight to the information provision duration to increase the information provision duration.

The method may further include determining whether an information termination condition is satisfied after providing the road condition information, and terminating the provision of the road condition information in a case where the information termination condition is satisfied.

Determining whether the information termination condition is satisfied may include determining that the information termination condition is satisfied based on determining that a preset information provision duration has elapsed.

Determining whether the information termination condition is satisfied may include determining that the information termination condition is satisfied based on determining that a reset information provision duration obtained by applying a weight to a preset information provision duration has elapsed.

Determining whether the information termination condition is satisfied may include receiving a road image provided by a third vehicle passing through a place where the service target object is located, while providing the road condition information, and determining that the information termination condition is satisfied based on determining that no service target object is detected from the received road image.

Determining whether the information termination condition is satisfied may include: receiving at least one of driving data or sensor data from a third vehicle passing through a place where the service target object is located, while providing the road condition information; and determining that the information termination condition is satisfied based on determining that at least one of the received driving data or sensor data does not correspond to a resetting condition of service provision information set in advance for provision of the road condition information.

Determining that the information termination condition is satisfied may include: determining that the information termination condition is satisfied based on determining, based on the sensor data received from the third vehicle, that vehicle body control for the third vehicle has not occurred.

Determining that the information termination condition is satisfied may include determining that the information termination condition is satisfied based on determining, based on the driving data received from the third vehicle, that there is no abnormality in a driving state of the third vehicle.

In accordance with another aspect of the present disclosure, a server for providing road condition information is provided. The server includes a memory storing a plurality of neural network models. The server also includes at least one processor configured to receive a road image provided by a first vehicle, and situation information corresponding to the road image. The at least one processor is also configured to determine, based on road type information included in the situation information, a neural network model, from among the plurality of neural network models, to be used to detect a service target object from the road image. The at least one processor is further configured to detect the service target object from the road image based on the neural network model.

The at least one processor is also configured to store road condition information associated with the detected service target object in a storage. The at least one processor is additionally configured to provide the road condition information to a second vehicle that enters a service target road.

In accordance with a further aspect of the present disclosure, a system for providing road condition information is provided. The system includes a first vehicle configured to provide a road image and situation information corresponding to the road image. The system also includes a server that includes memory storing a plurality of neural network models The server is configured to determine, based on road type information included in the situation information, a neural network model, from among a plurality of neural network models, to be used to detect a service target object from the road image. The server is also configured to detect the service target object from the road image based on the neural network model. The server is further configured to store road condition information associated with the service target object in a storage. The server is additionally configured to provide the road condition information to a second vehicle that enters a service target road.

### BRIEF DESCRIPTION OF THE DRAWINGS

The above and other aspects, features, and advantages of the present disclosure should be more clearly understood from the following detailed description taken in conjunction with the accompanying drawings, in which:

FIG. 1 is a diagram showing a road condition information provision system configured to implement a road condition information provision method according to an embodiment of the present disclosure;

FIG. 2 is a diagram showing an example of configuration of a single-structure server according to an embodiment of the present disclosure;

FIG. 3 is a diagram showing an example of configuration of a multi-structure server according to an embodiment of the present disclosure;

FIG. 4 is a diagram illustrating a road condition information provision method according to an embodiment of the present disclosure; and

FIG. 5 is a diagram illustrating a method for training a neural network model of the server according to an embodiment of the present disclosure.

### DETAILED DESCRIPTION

Hereinafter, certain embodiments of the present disclosure are described in more detail with reference to the accompanying drawings. Wherever possible, the same reference numbers are used throughout the drawings to designate the same or like components. It should be understood that the accompanying drawings are given by way of illustration and do not limit the present disclosure. The present disclosure is intended to cover various alternatives, modifications, equivalents and other embodiments, within the spirit and scope of the present disclosure as defined by the appended claims.

It should be understood that, although the terms “first”, “second”, etc. may be used herein to describe various elements, these elements should not be limited by these terms. These terms are merely used to distinguish one element from another.

As used herein, the singular forms “a”, “an”, and “the” are intended to include the plural forms as well, unless the context clearly indicates otherwise.

It should be further understood that the terms “comprise”, “include”, and “have” used herein merely specify the presence of stated features, numbers, steps, operations, components, parts, or combinations thereof, but do not preclude the presence or addition of one or more other features, numbers, steps, operations, components, parts, or combinations thereof.

The suffixes “module” and “unit” for components used in the following description are given or used interchangeably merely for ease of description of the specification, and do not have distinct meanings or roles in themselves.

Further, it should be understood that, when an element is “connected” or “coupled” to another element, it may be directly connected or coupled to the other element, or may be indirectly connected or coupled to the other element with a different element being interposed therebetween. In contrast, when an element is “directly connected” or “directly coupled” to another element, this means that there is no intervening element therebetween.

In addition, a “unit” or a “control unit” included in names of a motor control unit (MCU), a hybrid control unit (HCU), or the like merely refers to a controller that controls specific vehicle functions, and does not refer to a generic functional unit.

For example, each control unit may include a communication device that communicates with other control units or sensors, a memory that stores an operating system or logic instructions and input/output information, and one or more processors that perform necessary determinations, operations, and the like.

In any configuration described herein, any number of components or various components may be included within the disclosure described herein. The components may include any combination of features described herein, and may be arranged in any configuration described herein. Concepts relating to structures, arrangements, uses, and operations of the components of the present disclosure may not only be applied to specific embodiments described herein, but may also be applied to any combination thereof. Embodiments having various arrangements and various features are described below with reference to the accompanying drawings.

In describing the embodiments, detailed description of related known technologies has been omitted where it was determined that the detailed description would obscure the gist of the present disclosure. Wherever possible, the same reference numbers are used throughout the drawings to designate the same or like components.

When a component, controller, device, element, unit, apparatus, or the like of the present disclosure is described as having a purpose or performing an operation, function, or the like, the component, controller, device, element, unit, apparatus, or the like should be considered herein as being “configured to” meet that purpose or to perform that operation or function. Each component, controller, device, element, unit, apparatus, and the like may separately embody or be included with a processor and a memory, such as a non-transitory computer readable media, as part of the apparatus.

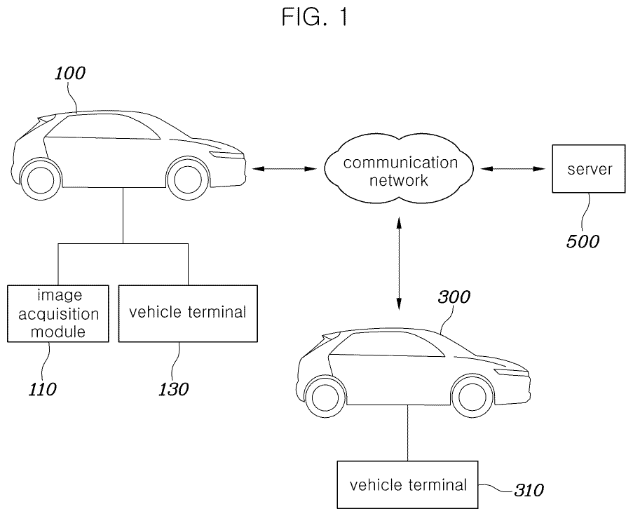

FIG. 1 is a diagram showing a road condition information provision system configured to implement a road condition information provision method according to an embodiment of the present disclosure.

Referring to FIG. 1, the road condition information provision system according to the embodiment of the present disclosure may include a first vehicle 100, a second vehicle 300, and a server 500.

In an embodiment, the road condition information provision system may include a base transceiver station provided on a road to form a communication network between the vehicles 100, 300 and the server 500. For example, the base transceiver station may be a roadside base transceiver station or a mobile base transceiver station, but the present disclosure is not limited thereto. In an example, the base transceiver station may perform communication between the vehicle 100, 300 and the server 500 in preset linked roads.

The communication network may include wireless Internet technologies such as Wi-Fi (Wireless LAN), WiBro (Wireless broadband) and/or WiMAX (World Interoperability for Microwave Access), and/or mobile communication technologies such as CDMA (Code Division Multiple Access), GSM (Global System for Mobile communication), LTE (Long Term Evolution), LTE-Advanced, and/or IMT (International Mobile Telecommunication)-2020.

### First Vehicle 100 and Second Vehicle 300

According to an embodiment of the present disclosure, the first vehicle 100 may provide a road image taken by an image sensor to the server 500. For example, the first vehicle 100 may be referred to as an “information provision vehicle”.

In FIG. 1, one first vehicle 100 is shown, but the present disclosure is not limited thereto, and a plurality of the first vehicles 100 may provide road images to the server 500.

According to an embodiment, the first vehicle 100 may provide information related to the road image (referred to hereinafter as “situation information”) to the server 500.

For example, the situation information may include light information at the time of imaging, imaging time information, vehicle location information, road link information, road type information, vehicle driving data, vehicle sensor data, vehicle driving direction information (or upbound/downbound road information), information on public offices in charge of roads, and/or the like.

The first vehicle 100 may include an image acquisition module 110 and a vehicle terminal (or a first vehicle terminal) 130.

The image acquisition module 110 may acquire a road image by photographing a front side of the first vehicle 100 during driving.

According to an embodiment, the image acquisition module 110 may acquire RGB images and depth data. For example, the image acquisition module 110 may include an RGB sensor, a radar sensor, a Lidar sensor, etc.

According to an embodiment, the image acquisition module 110 may additionally obtain light level information. For example, the image acquisition module 110 may further include a light sensor.

The vehicle terminal 130 may provide a road image including an RGB image and depth data, and situation information to the server 500.

For example, the vehicle terminal 130 may implement an IVI (In-Vehicle Infotainment) system in the first vehicle 100. For example, the vehicle terminal 130 may provide a navigation service. For example, the vehicle terminal 130 may communicate with the server 500. In an example, the vehicle terminal 130 may provide a connected car service (CCS)

According to an embodiment, the second vehicle 300 may receive road condition information from the server 500. For example, the second vehicle 300 may be referred to as an “information receiving vehicle”.

In an embodiment, the second vehicle 300 may receive pothole information from the server 500. As another example, the second vehicle 300 may, additionally or alternatively, receive other obstacle information from the server 500. Here, other obstacles may mean obstacles other than a pothole.

For example, other obstacles may be stones, trees, roadkill, plastics, etc., and may include objects that are located on the road and may interfere with vehicle driving.

The second vehicle 300 may receive road pothole information and other obstacle information from the server 500.

The second vehicle 300 may output the road pothole information and other obstacle information provided by the server 500 through a vehicle terminal (or a second vehicle terminal) 310.

In the above description, the first vehicle 100 and the second vehicle 300 are divided into the information provision vehicle and the information receiving vehicle, but the first vehicle 100 and the second vehicle 300 may perform both the functions of the information provision vehicle and the information receiving vehicle.

For example, the vehicle terminal 310 may implement an IVI (in-Vehicle Infotainment) system in the second vehicle 300. For example, the vehicle terminal 310 may provide a navigation service. For example, the vehicle terminal 310 may communicate with the server 500. For example, the vehicle terminal 310 may provide a connected car service (CCS).

According to an embodiment, in a case where the vehicle terminal 310 receives the road condition information from the server 500, the vehicle terminal 310 may determine a road condition information output method based on the type of a driving road of the second vehicle 300.

For example, the vehicle terminal 310 may output the road condition information via a voice output unit or a display depending on the type of the driving road of the second vehicle 300.

For example, the vehicle terminals 130 and 310 may include a memory, a storage, a communication module, a processor, a user interface, and/or the like.

The memory may store algorithms (or programs or software), data, etc. for executing operations of the vehicle terminals 130 and 310. The storage may store information, etc. acquired during the operations of the vehicle terminals 130 and 310.

For example, the memory and storage may include at least one storage medium (recording medium) among a flash memory, a hard disk, an SD card (Secure Digital Card), a RAM (Random Access Memory), an SRAM (Static Random Access Memory), a ROM (Read Only Memory), a PRPOM (Programmable Read Only Memory), an EEPROM (Electrically Erasable Programmable Read Only Memory), an EPROM (Erasable and Programmable ROM), a register, and/or a removable disk.

The communication module may communicate with external devices. For example, the communication module may include a communication circuit configured to communicate with the server 500.

For example, the communication module may communicate with the server 500 based on a wireless network. The wireless communication network may include wireless Internet technologies such as WLAN (Wireless LAN) (Wi-Fi), WiBro (Wireless broadband) and/or WiMAX (World Interoperability for Microwave Access), and/or mobile communication technologies such as CDMA (Code Division multiple Access), GSM (Global System for Mobile communication), LTE (Long Term Evolution), LTE-Advanced, and/or IMT (International Mobile Telecommunication)-2020.

The processor may perform the overall operations of the vehicle terminals 130 and 310, and may be operated based on algorithms and data stored in the memory, information stored in the storage, and information provided by the in-vehicle control units and sensors.

The processor may be a data processor that is a hardware device having a physical circuit for executing desired operations. For example, the desired operations may include code or instructions included in programs. For example, the data processor may include a microprocessor, a central processing unit, a processor core, a multi-core processor, a multiprocessor, an ASIC (Application-Specific Integrated Circuit), and/or an FPGA (Field Programmable Gate Array).

The user interface may receive user inputs. For example, the user interface may output a GUI (Graphical User Interface). For example, the user interface may output a USM (User Setting Menu). For example, the user interface may include devices that output various information. For example, the user interface may include a speaker, a display device, and/or the like.

### Server 500

According to an embodiment, the server 500 may perform learning based on road images provided by the first vehicle 100. In addition, the server 500 may perform learning based on road images provided in advance for learning.

For example, in a case where the server 500 performs the learning based on the road images provided by the first vehicle 100, the server 500 may determine whether to perform the learning for the road images based on the light level information included in the situation information provided with the road images.

For example, the server 500 may perform the learning based on the road images corresponding to a case where the light level associated with the road images is equal to or higher than a preset threshold, thereby improving object recognition performance of the server 500.

Depending on road environments, objects that are dangerous and objects that are not dangerous may be different. In addition, depending on road types, types of objects that may be identified or recognized by the vehicle may be different.

Accordingly, the server 500 may include a plurality of neural network models, and road image sets used for learning the plurality of neural network models may be different.

In an embodiment, the plurality of neural network models may learn the road image sets so as to be selectively applied according to the road types. Thus, each of the plurality of neural network models may be trained to be suitable for a specific road type.

According to an embodiment, the server 500 may receive a road image and situation information from the first vehicle 100.

According to an embodiment, the server 500 may apply the road image provided by the first vehicle 100 to a neural network model to detect an object included in the road image, and may store road condition information in a case where the detected object is a service target (for example, potholes, other obstacles, or the like).

In an embodiment, the road condition information may include road link information, object location information, object type information (potholes, other obstacles), risk level information, and/or the like.

In an embodiment, in a case where the object corresponds to a pothole, the road condition information may be expressed as pothole information, and in a case where the object corresponds to other obstacles, the road condition information may be expressed as other obstacle information.

According to an embodiment, the server 500 may extract a feature from the road image provided by the first vehicle 100, and may determine whether the road image includes potholes, quasi-potholes, and other obstacles based on the extracted feature.

For example, the quasi-potholes may include flat-potholes, cracks, and/or the like.

In a case where the server 500 determines that the road image includes potholes or other obstacles, the server 500 may detect an object included in the road image by inputting the road image to a neural network model corresponding to road type information included in the situation information.

According to an embodiment, in a case where a road type included in the road type information is a first road type (for example, highway), the server 500 may input the road image to a first neural network model.

According to an embodiment, in a case where the road type included in the road type information is a second road type (for example, national highways), the server 500 may input the road image to a second neural network model.

According to an embodiment, in a case where the road type included in the road type information is a third road type (for example, local road, metropolitan city road, provincial road, county road, district road, or the like), the server 500 may input the road image to a third neural network model.

Here, the classification of the road types is not limiting since the road types differ according to road features, management authorities, functions, usage types, sizes, and the like.

According to an embodiment, the server 500 may provide the road condition information to the second vehicle 300 entering a service target road.

In an embodiment, the server 500 may provide the pothole information to the second vehicle 300 entering the service target road. In the present embodiment, the server 500 may provide the other obstacle information to the second vehicle 300 entering the service target road.

In a case where the server 500 determines that a quasi-pothole is included in the road image, the server 500 may detect an object included in the road image by inputting the road image to a fourth neural network model (or additional neural network model), and may provide road analysis information to a server of a road office in charge of the road (hereinafter, road management server) included in the situation information.

For example, the road analysis information may include road link information, object location information, object state information, and the like. For example, the object state information may include information about whether the road has peeled or cracked.

According to an embodiment, the server 500 may not provide information on repaired potholes. According to an embodiment, the server 500 may not provide information about an object that does not interfere with a vehicle's operation, or an object that is temporarily located on the road. For example, the server 500 may not provide information about rubber, ropes, clothes, shoes, vinyl, or the like.

According to an embodiment, the server 500 may not perform learning for road images including repaired potholes, rubber, ropes, clothes, shoes, vinyl, or the like.

The server 500 may apply different service methods depending on the road type (for example, service target road) on which the second vehicle 300 is located and the type of the object included in the road image.

According to an embodiment, the server 500 may apply different times (information provision duration) for providing the road condition information depending on the type of the service target road and the type of the object.

For example, the server 500 may apply different information provision durations taking into account a work time for treating the object on the service target road. For example, in the case of a short work time, the information provision duration may be set shorter than the information provision duration in the case of a long work time.

For example, the information provision duration in a case where the object corresponds to a pothole may be set to be longer than the information provision duration in a case where the object corresponds to other obstacles.

According to an embodiment, in providing the road condition information, the server 500 may apply a weight based on driving data, sensor data, and/or the like of a vehicle passing through a place where the service target object (for example, potholes, other obstacles) is located (referred to as a third vehicle hereinafter).

For example, based on determining that vehicle body control for the third vehicle has occurred based on the sensor data of the third vehicle, the server 500 may apply a weight in providing the road condition information. For example, the server 500 may determine whether the vehicle body control for the third vehicle has occurred based on an operation signal of an ABS (Anti-lock Brake System), an operation signal of a TCS (Traction Control System), an operation signal of an ECS (Electronically Controlled Suspension), and the like.

For example, the server 500 may apply a higher weight in providing the road condition information according to a duration of the vehicle body control for the third vehicle. For example, the server 500 may increase the road condition information provision duration, or may increase the risk level information based on the weight.

Based on determining that there is an abnormality in the driving state based on the driving data of the third vehicle, the server 500 may apply a weight in providing the road condition information.

For example, the server 500 may determine an avoidance driving tendency of the third vehicle based on the driving data of the third vehicle. For example, the server 500 may determine the driving state of the third vehicle based on the magnitude of a steering wheel (steering angle) change of the third vehicle, the level of brake pedal pressure, and the frequency of operations of an LDWS (Lane Departure Warning System).

For example, in a case where the driving data used to determine the driving state of the third vehicle is equal to or greater than a threshold, the server 500 may apply a weight in providing the road condition information. For example, the threshold may be set to three times an average value of the driving data, but is not limited thereto.

According to an embodiment, the server 500 may provide the road condition information until an information termination condition is satisfied.

For example, in a case where a preset information provision duration (default information provision duration or first information provision duration) has elapsed depending on the type of the service target road and the type of the object, the server 500 may terminate the provision of the road condition information.

For example, in a case where an information provision duration (reset information provision duration, extended information provision duration, or second information provision duration) set by extending the default information provision duration according to weight application has elapsed, the server 500 may terminate the provision of the road condition information.

According to an embodiment, while the server 500 provides the road condition information, in a case where no service target object is detected in the road image provided by the third vehicle passing through the point where the service target object (for example, potholes, or other obstacles) is located, the server 500 may terminate the provision of the road condition information even in a case where the information provision duration (the default information provision duration and the reset information provision duration) has not elapsed.

In an embodiment, while the server 500 provides the road condition information, the server 500 may further determine whether the driving data and sensor data provided by the third vehicle passing through the point where the service target object (for example, potholes, other obstacles) is located corresponds to a resetting condition of the service provision information. In a case where the driving data and sensor data do not correspond to the resetting condition, the server 500 may terminate the provision of the road condition information even in a case where the information provision duration (default information provision duration, reset information provision duration) has not elapsed.

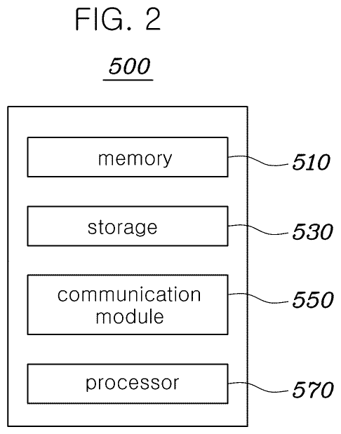

FIG. 2 is a diagram showing an example of configuration of a single-structure server 500 according to an embodiment of the present disclosure.

Referring to FIG. 2, the server 500 may include a memory 510, a storage 530, a communication module 550, and a processor 570, but the configuration of the server 500 is not limited thereto. For example, the server 500 may be linked with a separate database.

The memory 510 may store algorithms (or programs or software), data, or the like for executing operations of the server 500. For example, the memory 510 may include an algorithm capable of executing a series of operations for providing road condition information, an object detecting algorithm, a variety of thresholds, weights, and/or the like.

The storage 530 may store information acquired or generated by the server 500. For example, the storage 530 may store road images and situation information provided by the first vehicle 100, driving data and sensor data provided by the second vehicle 300, road condition information generated by the server 500, and the like.

The communication module 550 may include a communication circuit for communicating with the vehicles 100 and 300 via a network.

The processor 570 may perform the overall operations of the server 500, and may be operated based on algorithms and data stored in the memory 510, information stored in the storage 530, and the like to provide a road condition information provision service.

According to the present embodiment, the server 500 may be a multi-structure server.

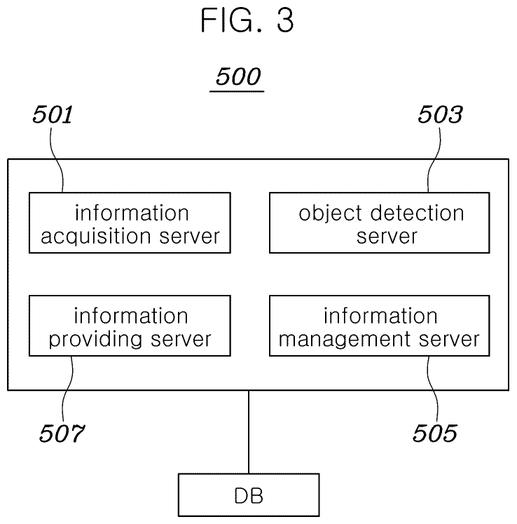

FIG. 3 is a diagram showing an example of configuration of a multi-structure server 500 according to an embodiment of the present disclosure.

Referring to FIG. 3, the server 500 may include a plurality of sub-servers 501, 503, 505, and 507, each of which may perform a part of functions of the server 500.

According to an embodiment, each of the plurality of sub-servers 501, 503, 505, and 507 may have the configuration shown in FIG. 2. According to an embodiment, in a case where each of the plurality of sub-servers 501, 503, 505, and 507 serves as only a processor, the plurality of sub-servers 501, 503, 505, and 507 may be referred to as “sub-processors”, and may serve as the processor 570 shown in FIG. 2.

The first sub-server 501 may collect road images and situation information from the first vehicle 100, and may be referred to an “information acquisition server”.

For example, the first sub-server 501 may sort road images by road types and times, and may store the result in a database (DB).

For example, the first sub-server 501 may collect sensor data and driving data from the second vehicle 300.

The second sub-server 503 may include a plurality of neural network models, and the plurality of neural network models may perform learning for object detection based on the road images stored in the database (DB).

According to an embodiment, the second sub-server 503 may detect an object from the road images provided by the first vehicle 100 using the plurality of neural network models. For example, the second sub-server 503 may be referred to as an “object detection server”.

According to an embodiment, in a case where the second sub-server 503 detects a service target object (for example, potholes or other obstacles) from the road images, the second sub-server 503 may output road condition information, and in a case where the second sub-server 503 detects quasi-potholes from the road images, the second sub-server 503 may output road analysis information.

For example, the second sub-server 503 may provide the road condition information and the road analysis information to the third sub-server 505.

The third sub-server 505 may receive the road condition information and the road analysis information provided by the second sub-server 503, and may store the road condition information and the road analysis information in the database (DB).

The fourth sub-server 507 may provide the road condition information stored in the database (DB) to the second vehicle 300. For example, the fourth sub-server 507 may provide pothole information or other obstacle information as the road condition information.

According to an embodiment, the fourth sub-server 507 may provide the road analysis information to a road management server of a road office in charge of the road.

For example, the third sub-server 505 may be referred to as an “information management server”, and the fourth sub-server 507 may be referred to as an “information provision server”.

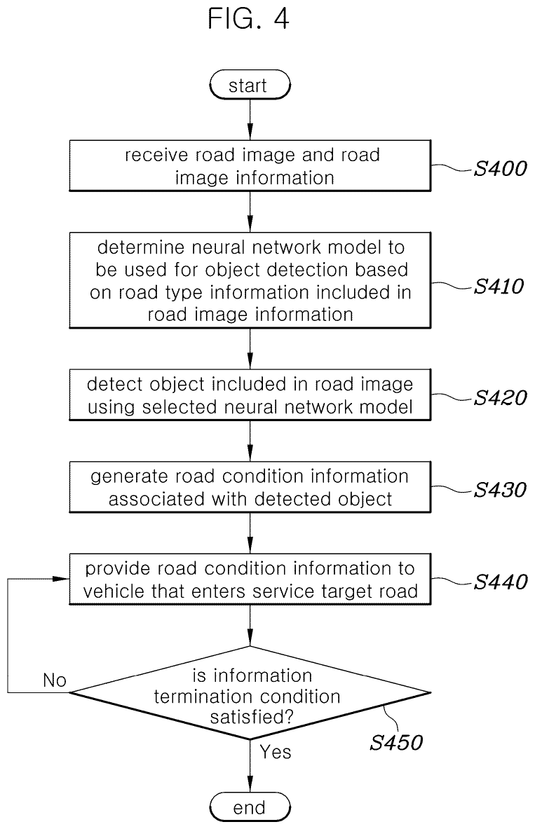

FIG. 4 is a diagram illustrating a road condition information provision method according to an embodiment of the present disclosure. Step-by-step operations shown in FIG. 4 may be performed by the server 500 according to the embodiment of the present disclosure.

Hereinafter, the road condition information provision method according to embodiment of the present disclosure are described in more detail with reference to FIG. 4. Here, it is assumed that an object is present in a road image.

Specifically, the road condition information provision method in a vehicle entering a road that is a road service target are described.

Referring to FIG. 4, in an operation S400, the server 500 may receive a road image and situation information from the first vehicle 100.

In an operation S410, the server 500 may determine a neural network model to be used for detection of a service target object among a plurality of neural network models, based on road type information included in the situation information.

For example, the plurality of neural network models may include a first neural network model trained to detect a service target object in a first road type image, a second neural network model trained to detect a service target object in a second road type image, and a third neural network model trained to detect a service target object in a third road type image.

For example, the first type road may be a road (for example, highway) where a speed exceeding a first threshold speed (for example, 80 km/h) is permitted, the second type road may be a road (for example, national highways) where a speed between the first threshold speed (for example, 80 km/h) and a second threshold speed (for example, 60 km/h) that is lower than the first threshold speed (for example, 60 km/h) is permitted, and the third type road may be a road (for example, local road) where a speed lower than the second threshold speed is permitted.

In an operation S420, the server 500 may detect the service target object included in the road image using the determined neural network model.

In the operation S420, the server 500 may detect a pothole and other obstacles as the service target object.

In an operation S430, the server 500 may generate road condition information associated with the detected service target object.

In the operation S430, in a case where the detected service target object corresponds to a pothole, the server 500 may generate pothole information as the road condition information, and in a case where the detected service target object corresponds to other obstacles, the server 500 may generate other obstacle information as the road condition information.

In an operation S440, the server 500 may provide the road condition information to the second vehicle 300 entering the service target road.

In an operation S440, the server 500 may provide the road condition information based on service provision information set in advance according to the type of the road and the type of the service target object.

For example, the service provision information may include information on an information provision duration.

According to the present embodiment, the server 500 may reset the service provision information based on driving data and sensor data provided by the third vehicle passing through a place where the service target object is located while providing the road condition information.

For example, based on determining that vehicle body control for the third vehicle has occurred based on the sensor data, the server 500 may apply a weight to the service provision information. As another example, based on determining that there is an abnormality in a driving state of the third vehicle based on the driving data, the server 500 may apply a weight to the service provision information.

For example, the weight may be applied to the information provision duration included in the service provision information.

In the operation S440, in a case where the service 500 resets the information provision duration, the server 500 may provide the road condition information based on the reset information provision duration.

In an operation S450, the server 500 may determine whether an information termination condition is satisfied.

In a case where the information termination condition is satisfied (YES in the operation S450), the server 500 may terminate the provision of the road condition information for the service target road.

In a case where the information termination condition is not satisfied (NO in in the operation S450), the server 500 may repeat the operation S440 to continuously provide the road condition information for the service target road.

In the operation S450, in a case where the information provision duration has elapsed, the server 500 may determine that the information termination condition is satisfied.

Here, the information provision duration may be a preset information provision duration or a reset information provision duration based on weight application.

In the operation S450, while the server 500 provides the road condition information, in a case where no service target object is detected for a predetermined period of time in the road image provided by the third vehicle passing through the place where the service target object (for example, potholes, or other obstacles) is located, the server 500 may determine that the information termination condition is satisfied even in a case where the information provision duration has not elapsed (that is, regardless of the information provision duration).

In the operation S450, while the server 500 provides the road condition information, in a case where the driving data and sensor data provided by the third vehicle passing through the point where the service target object (for example, potholes, other obstacles) is located does not correspond to a weight application condition, the server 500 may determine that the information termination condition is satisfied even in a case where the information provision duration has not elapsed.

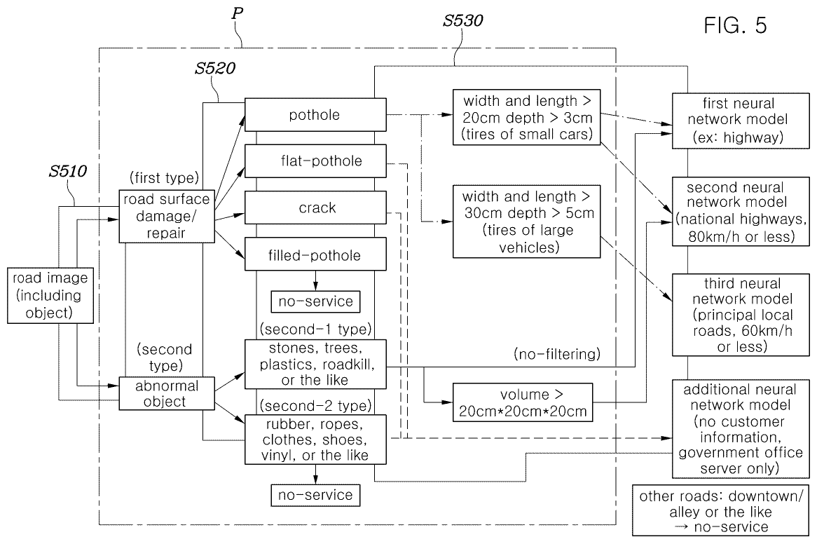

FIG. 5 is a diagram illustrating a method for training a neural network model of the server 500 according to an embodiment of the present disclosure.

Referring to FIG. 5, in an operation S510, a processor (P) may detect objects from a road image, and may classify the detected objects accord to type.

For example, the processor (P) may classify the objects into an object type (first type object) that corresponds to road damage or requires repair and an object type (second type object) that corresponds to an abnormal object.

In an operation S520, the processor (P) may further classify in detail the classified objects.

According to the present embodiment, the processor (P) may classify the first type object into potholes, flat-potholes, cracks, and filled-potholes.

According to the present embodiment, the processor (P) may further classify the second type object into a second-1 type and a second-2 type.

For example, the second-1 type may include objects (other obstacles) that are located on the road and may interfere with vehicle driving, such as stone, wood, plastic, roadkill. For example, the second-2 type include objects that do not interfere with vehicle driving or are temporarily located on the road, such as rubber, ropes, clothes, shoes, and vinyl.

According to the present embodiment, the repaired pothole (filled-pothole) and the second-2 type correspond to objects that are not included in the road state information, and therefore, are not used for training the neural network model.

In an operation S530, the processor (P) may input the object into the neural network model based on the detailed classification.

According to the present embodiment, filtering may be performed according to types of objects in the process of inputting the detailed classified objects to the neural network model.

For example, the processor (P) may apply filtering to input a pothole with the size and depth of a first reference to the first neural network model and the second neural network model, and to input a pothole with the size and depth of a second reference to the third neural network model.

For example, in a case where the object corresponds to a flat-pothole or a crack, the processor (P) may input the object to an additional neural network model.

For example, the processor (P) may input the second-1 type object to the first neural network model, may input the second-1 type object that satisfies a preset reference volume by applying filtering to the second-1 type object to the second neural network model.

In this way, the neural network models used for object detection may perform learning based on different object groups, and may be trained to specialize in detecting specific object groups.

Table 1 shows examples of road characteristics to which the neural network models according to the present embodiment are applied.

TABLE 1

| Neural network | |
|---|---|
| model | Road characteristics |
| First neural | Generally, situation in which there should |
| network model | be no falling objects other than vehicle |
| (Ex: | Clear identification of road area is |
| Expressway, | possible |
| over 80 | Some obstacles may have significant effect |
| kilometers per | on vehicle/traffic |
| hour (km/h)) | |
| Second neural | High speed driving above set speed is |
| network model | common, and road environment |
| (Ex: National | (quality/lighting) is often not good |
| highways and | compared to highway |
| Principal local | Identification of road area is possible to |
| roads, 60-80 | some extent (below highway level) |
| km/h) | |
| Third neural | High speed driving is not common, |
| network model | medium/low speed + many traffic lights |
| (Up to 60 km/h, | Identification of driving area is |
| general roads) | possible, but it is difficult to clearly |
| | identify section that goes beyond road, and |
| | to distinguish between objects that |
| | interfere with driving and objects that do |
| | not interfere with driving on road |
| Additional | Identification on road is possible, but |
| neural network | model for detection of an object that is |
| model | identifiable on road but is provided for |
| (Special | special purposes, not for customer |
| Purpose) | guidance, to only road maintenance entity |
| | (expressway corporation or local government, |
| | etc.) |

Table 2 shows examples of objects learned by the neural network models according to the present embodiment.

TABLE 2

| Neural network | |
|---|---|
| model | Learning Objects (Learning reason) |
| First neural | Potholes with width of 20 cm and depth of |
| network model | 3 cm or greater (level that may be affected |
| (Ex: | based on tires of small cars) |
| Expressway, | Abnormal objects (solid and clear objects |
| over 80 km/h) | in shape, such as stone, wood, plastic, |
| | roadkill, etc., all of which are learning |
| | objects regardless of size) |
| | → Even temporary falling objects may |
| | affect vehicle/traffic |
| | → Such objects may be clearly identified |
| | due to being clearly distinguished from |
| | general road area |
| | → Objects that have little driving affect, |
| | such as cloth, string, rubber, among |
| | abnormal objects are excluded from learning |
| | objects |
| Second neural | Potholes with width of 20 cm and depth of |
| network model | 3 cm or greater (level that may be affected |
| (Ex: National | based on tires of small cars) |
| highways and | Abnormal objects (solid and clear objects |
| principal local | in shape such as stone, wood, plastic, |
| roads, 60- | roadkill, etc., of which only objects with a |
| 80 km/h) | certain volume (20 cm*20 cm*20 cm) or greater) |
| | are learning objects |
| | → Small falling objects having little |
| | significance compared to expressways are |
| | excluded from learning objects |
| | Objects with little driving effect such as |
| | cloth, string, rubber, etc. among abnormal |
| | objects are excluded from learning objects |
| Third neural | Potholes with width of 30 cm and depth of |
| network model | 5 cm or greater (level that may be affected |
| (Up to 60 km/h, | based on tires of large vehicles) |
| on general | No learning of abnormal objects (it is |
| roads ) | often difficult to identify driving area, |
| | and it difficult to distinguish |
| | between abnormal objects and ordinary |
| | objects in areas other than road areas) |
| Additional | Cracks, flat-potholes |
| neural network | Customer guidance is unnecessary, but |
| model | objects that need to be recognized by agency |
| (Special | in charge |
| Purpose) | |

Table 3 shows examples of informational scenarios for respective roads to which the neural network models according to the present embodiment are applied.

TABLE 3

| Neural network | |
|---|---|
| model | Informational Scenarios |
| First neural | Active guidance through voice |
| network model | Potholes: 6 (in consideration of |
| (Ex: | maintenance time) |
| Expressway, | Other objects: 30 minutes (usually fast |
| over 80 km/h) | maintenance) |
| Second neural | Active guidance through voice |
| network model | Potholes: 24 hours (slow maintenance) |
| (Ex: National | Other objects: 2 hours (due to provision |
| highways and | of object type information) |
| principal local | |
| roads, 60- | |
| 80 km/h) | |
| Third neural | Map marking and pop-up (passive guide) |
| network model | Potholes: 24 hours |
| (Up to 60 km/h, | Other objects: 2 hours |
| on general | |
| roads ) | |
| Additional | No customer information |
| neural network | |
| model | |
| (Special | |
| Purpose) | |

As should be more apparent from the above description, it is possible to provide a road condition information provision method capable of providing accurate road condition information, particularly, providing accurate road pothole information by learning road images including a plurality types of road conditions, and a server and a system for the same.

According to embodiments of the present disclosure, it is possible to provide a road condition information provision method capable of improving accuracy and efficiency of road pothole determination by performing learning excluding objects (for example, flat-potholes, cracks, filled-potholes, etc.) that are main misdetection targets in determining road potholes, and a server and a system for the same.

According to embodiments of the present disclosure, it is possible to provide a road condition information provision method capable of providing accurate road pothole information for each road type by determining road potholes using a neural network model trained based on different road images according to road types, and a server and a system for the same.

According to embodiments of the present disclosure, it is possible to provide a road condition information provision method capable of preventing unnecessary information notification in advance by releasing, in a case where a road pothole is not detected for a predetermined threshold time from a road image provided by a vehicle passing through a place where it is determined that the road pothole exists, the notification for the place, a server and a system for the same.

According to embodiments of the present disclosure, it is possible to provide a road condition information provision method capable of performing maintenance for dangerous factors by detecting quasi-potholes using a separate neural network model trained based on road images including the quasi-potholes (for example, flat-potholes, cracks, etc.) and providing information on abnormal road conditions (for example, flat-potholes, cracks, etc.) to a relevant government office, and a server and a system for the same.

By providing the road pothole information provision method according to the present disclosure to a road condition information provision system, it is possible to improve accuracy and efficiency for determination of road potholes, and to provide accurate information on road potholes, thereby improving the degree of customer satisfaction.

The effects that may be obtained from the present disclosure are not limited to the above-mentioned effects, and other effects not mentioned may be clearly understood by those skilled in the technical field to which the present disclosure belongs from the following description.

Although example embodiments of the present disclosure have been described for illustrative purposes, those having ordinary skill in the art should appreciate that various modifications, additions and substitutions are possible, without departing from the scope and spirit of the disclosure as disclosed in the following claims.

What is claimed is:

1. A method for providing road condition information, the method comprising:
receiving, by a server, a road image provided by a first vehicle and situation information corresponding to the road image;
determining, by the server, based on road type information included in the situation information, a neural network model, among a plurality of neural network models, to be used to detect a service target object in the road image;
detecting, by the server, the service target object from the road image based on the neural network model;
storing, by the server, road condition information associated with the service target object in a storage; and
providing, by the server, the road condition information to a second vehicle that enters a service target road.

2. The method according to claim 1, wherein respective neural network models, among the plurality of neural network models, are trained to detect the service target object from images acquired from roads of respective road types among a plurality of road types.

3. The method according to claim 2, wherein the plurality of road types have different speed limits.

4. The method according to claim 1, wherein at least one of a size range or a volume range of service target objects detectable by respective neural network models, among the plurality of neural network models, is different.

5. The method according to claim 1, wherein the service target object comprises at least one of a pothole and one or more obstacles other than a pothole.

6. The method according to claim 1, wherein providing the road condition information includes providing the road condition information based on service provision information preset according to a road type and the service target object.

7. The method according to claim 6, wherein the service provision information includes an information provision duration,
wherein the information provision duration is set to be longer as a speed limit according to the road type becomes higher, and
wherein the information provision duration for the service target object being a pothole is set to be longer than the information provision duration for the service target object being an obstacle other than a pothole.

8. The method according to claim 6, wherein providing the road condition information includes:
receiving at least one of driving data or sensor data from a third vehicle passing through a place where the service target object is located, while providing the road condition information;
resetting the service provision information based on at least one of the driving data or the sensor data received from the third vehicle; and
providing the road condition information based on the reset service provision information.

9. The method according to claim 8, wherein resetting the service provision information includes resetting the service provision information based on determining, based on the sensor data received from the third vehicle, that vehicle body control for the third vehicle has occurred.

10. The method according to claim 8, wherein resetting the service provision information includes resetting the service provision information based on determining, based on the driving data received from the third vehicle, that there is an abnormality in a driving state of the third vehicle.

11. The method according to claim 8, wherein:
the service provision information includes an information provision duration, and
resetting the service provision information includes applying a weight to the information provision duration to increase the information provision duration.

12. The method according to claim 1, further comprising:
determining, by the server, whether an information termination condition is satisfied after providing the road condition information; and
terminating, by the server, provision of the road condition information based on determining that the information termination condition is satisfied.

13. The method according to claim 12, wherein determining whether the information termination condition is satisfied includes determining that the information termination condition is satisfied based on determining that a preset information provision duration has elapsed.

14. The method according to claim 12, wherein determining whether the information termination condition is satisfied includes determining that the information termination condition is satisfied based on determining that a reset information provision duration obtained by applying a weight to a preset information provision duration has elapsed.

15. The method according to claim 12, wherein determining whether the information termination condition is satisfied comprises:
receiving a road image provided by a third vehicle passing through a place where the service target object is located, while providing the road condition information; and
determining that the information termination condition is satisfied based on determining that no service target object is detected from the road image provided by the third vehicle.

16. The method according to claim 12, wherein determining whether the information termination condition is satisfied comprises:
receiving at least one of driving data or sensor data from a third vehicle passing through a place where the service target object is located, while providing the road condition information; and
determining that the information termination condition is satisfied based on determining that at least one of the driving data or the sensor data received from the third vehicle does not correspond to a resetting condition of service provision information set in advance for provision of the road condition information.

17. The method according to claim 16, wherein determining that the information termination condition is satisfied comprises determining that the information termination condition is satisfied based on determining, based on the sensor data received from the third vehicle, that vehicle body control for the third vehicle has not occurred.

18. The method according to claim 16, wherein determining that the information termination condition is satisfied comprises determining that the information termination condition is satisfied based on determining, based on the driving data received from the third vehicle, that there is no abnormality in a driving state of the third vehicle.

19. A server for providing road condition information, the server comprising:
a plurality of neural network models stored in a memory, and
at least one processor configured to:
receive a road image provided by a first vehicle and situation information corresponding to the road image,
determine, based on road type information included in the situation information, a neural network model, from among the plurality of neural network models, to be used to
detect a service target object from the road image, detect the service target object from the road image using the neural network model,
store road condition information associated with the detected service target object in a storage, and
provide the road condition information to a second vehicle that enters a service target road.

20. A road condition information provision system comprising:
a first vehicle configured to provide a road image and situation information corresponding to the road image; and
a server that includes a memory storing a plurality of neural network models,
wherein the server is configured to:
select, based on road type information included in the situation information, a neural network model, from among the plurality of neural network models, to be used to detect a service target object from the road image,
detect the service target object from the road image using the neural network model,
store road condition information associated with the detected service target object in a storage, and
provide the road condition information to a second vehicle that enters a service target road.
